(19) United States
(12) Patent Application Publication
(10) Pub. No.: US 2010/0121814 A1
(43) Pub. Date: May 13, 2010

(54) SYSTEM AND METHOD FOR BIOTECHNOLOGY DATA MANAGEMENT

(76) Inventors: Nathan Eton McQueen, Seattle, WA (US); Nicholas Allen Haddow, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 12/579,763

(22) Filed: Oct. 15, 2009

Related U.S. Application Data
(60) Provisional application No. 61/106,531, filed on Oct. 17, 2008.

(51) Int. Cl. G06F 17/30

(52) U.S. Cl. 707/609; 707/E17.005

(57) ABSTRACT

An embodiment of the invention is a system and method that supports Enterprise Resource Planning, Laboratory and Research Management, Product Lifecycle Management, Decision Support Management, Regulatory Document Management, and internal corporate documents and data into a comprehensive, Web-based extranet, that can be a repository for a complete, real-time Body of Knowledge of an organization.

### PRIORITY CLAIM

This application claims priority from earlier filed U.S. Provisional Patent Application Ser. No. 61/106,531 filed Oct. 17, 2008. The foregoing application is hereby incorporated by reference in its entirety as if fully set forth herein.

### COPYRIGHT NOTICE

This disclosure is protected under United States and International Copyright Laws.© 2008-2009 BioTech Data Systems, Inc. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### REFERENCE TO APPENDIX

This application includes a computer program listing appendix filed on a compact disc as a text file entitled “code.txt” (0.99 MB, created Oct. 17, 2008). The computer program listing appendix is incorporated herein by reference.

### FIELD OF THE INVENTION

This invention relates generally to system and method of technology data management more specifically, related to the aggregation and management of data generated during the various stages of research, development, technology transfer, and commercialization of new therapies, compounds, and compositions, and more specifically within a regulatory submission framework. Research fields to which this invention pertains include but are not limited to, Pharmacology, Agro-Technology, Bio-Chemistry, Bio-Control, Bio-Dynamics, Bio-Engineering, Biology, Bio-Materials, Bio-Technology, Bio-Medical Engineering, Bio-Medical Systems, Bio-Molecular Engineering, Bio-Physics, Cell Biology, Ecology, Environmental Sciences, Genetics and Genomics, Molecular Biology, Nanotechnology.

### BACKGROUND OF THE INVENTION

Biotechnology and other related research endeavors generate tremendous amounts of data at a rate which has never been seen in any other discipline of science. One of the biggest issues in research and development relates to the difficulties in organizing the vast amounts of rapidly generated data, channeling that data to the appropriate parties for review, and reviewing the information in an actionable manner. The common data generating systems in which scientists and researchers operate are generally free-form. For example, a local-area network in a research institute consists of information producers (researchers, scientists and staff) who enter information in an arbitrary format, using any of the commonly-available or proprietary applications programs, such as word processors, spreadsheets, databases etc. The lack of a unified and integrated data management structure leads to increases in time and expense in the research pipeline and often results in unfinished, lost, and/or unanalyzed results, duplicative efforts amongst research teams, underreporting of failed experimental attempts, missed collaborative opportunities, and the like.

One previous approach to dealing with some of the issues in the research sphere includes Microsoft Dynamics AX for Life Sciences data management including systems to manage financial processes, in particular, those designed to shorten the budget cycle and generate accurate financial forecasts using budgeting and forecasting tools. Microsoft Dynamics AX for Life Sciences also addresses regulatory compliance initiatives with a framework for storing, categorizing, and searching compliance documents, tracking document modifications, and ensuring that managers have the necessary data and materials to maintain compliance.

Other examples of similar solutions include Siemens Teamcenter® for Medical Devices which teaches unifies the entire medical devices product lifecycle from product ideation through product retirement. The Teamcenter® solution takes a holistic approach to compliance management that captures, manages, tracks and reports on a medical device's regulatory requirements as these requirements evolve across a product lifecycle that includes an enterprise's design, manufacturing, test and service operations.

TranSenda Office-Smart Clinical Trial Manager™ solutions are another category of software which is basically the result of blending a clinical study application with the Microsoft® Office System. To make Clinical Trial Manager™ “Office-Smart”, TranSenda has taken a “line-of-business” (LOB) application—in this case a clinical trial management system (CTMS)—and optimized it to interoperate with the Microsoft® Office System in ways that make the most sense for study professionals. Microsoft® calls a solution that connects LOB applications, systems, processes and people with the familiar Microsoft® Office interface an Office Business Application (OBA). Office-Smart Clinical Trial Manager is essentially an OBA-based CTMS.

Another approach is exemplified by Ross Enterprise approach which incorporates a series of Enterprise Resource Planning applications, Supply Chain Planning (SCP) applications, Supply Chain Execution (SCE) applications, Customer Relationship Management (CRM) applications, and Enterprise Performance Management (EPM) applications.

Prior approaches however have collectively failed to address problems related to pipeline data management in the research and development sectors and specifically the provision of real-time data awareness at the executive level. As a group, the expense of implementation prohibits emerging companies from appropriately leveraging technologies such as social networking and community feedback techniques to research and development cycles, resulting in ad hoc data management at critical time-points in the development lifecycle when a cohesive strategy is most beneficial.

In addition, prior approaches have failed to effectively aggregate all of the critical data, by focusing on one part or another of the business process. As a result, the body of knowledge is often incomplete not actionable, and multiple data points must be referenced in order to compile an accurate representation of the data in question.

What is needed is a system and method to enable all users in a research and development pipeline with real-time interactive functionality that aggregates a body of knowledge and provides interaction amongst working groups irrespective of the geographical location of the working groups. This is increasingly important as companies look to outsourcing enterprise processes to help defray rising development costs.

### SUMMARY OF THE INVENTION

A system and method that supports Enterprise Resource Planning, Laboratory and Research Management, Product Lifecycle Management, Decision Support Management, Regulatory Document Management, and all internal corporate documents and data into a single, Web-based extranet, which is a repository for the complete, real-time Body of Knowledge of an organization.

An embodiment of the present invention comprises a BioTech Data Portal (BTDS) system for collaboration between researchers and management facilitating critical decisions regarding research and company direction to be made at the executive level, based on real-time data awareness, based on data entry by a researcher.

In accordance with some examples of the invention the BTDS system can be a company-wide resource, allowing personnel to share data and access a complied and aggregated body of knowledge, which can be inclusive of in-house and/or institutional knowledge irrespective of the geographical location of the personnel.

In accordance with an exemplary embodiment of the invention, Web 2.0 Social Networking and Community Feedback methods can be applied to clinical research and development cycles, allowing rich collaboration between participants.

In accordance with still further examples of the invention Real-time data awareness at the Executive level can be accomplished by combining comprehensive data-monitoring and customizable threshold-based alerts with email and Instant Message notification into the BTDS RDA (Rapid Data Awareness) system.

In accordance with still further examples of the invention mobile-device User Interfaces enable personnel to access critical information from different geographical locations. These features in tandem with the above-mentioned data awareness functionality can provide a method for informing critical business decisions at the highest levels of an organization, based on real-time data generated at any point of the company's business process.

In accordance with still further examples of the invention, a Fluid Assay Builder (FAB) allows research personnel to create custom assay datasets and input interfaces created when needed and/or responsive to user, eliminating the need for specialized programming knowledge when initializing a new assay in the laboratory environment.

In accordance with still further examples of the invention, Drag & Drop functionality allows word-processing, and/or data-handling documents (e.g., spreadsheets), for example, but not limited to, Microsoft® Office Excel documents to be imported easily into the FAB, creating relational datasets and user interfaces based on legacy document files.

In accordance with still further examples of the invention a BTDS Lab-Toaster laboratory instrument interface allows for data output from laboratory and/or research instruments and/or devices to be transformed into an XML document corresponding to an electronic common technical document (eCTD) specification for inclusion in the regulatory process, for example, submission to government agencies such as the U.S. Food and Drug Administration, for approval procession.

In accordance with still further examples of the invention the BTDS AutoCTD component can assemble and compile a complete eCTD for electronic submission to regulatory agencies with the click of a button.

In accordance with still further examples of the invention the BTDS LAB-IP system automatically compiles an XML-based document from compound genesis data to be used in the Intellectual Property protection process. Used in conjunction with the RDA component, LAB-IP can notify legal personnel when a new compound is ready to enter the IP protection process.

### BRIEF DESCRIPTION OF THE DRAWINGS

Preferred and alternative examples of the present invention are described in detail below with reference to the following drawings:

FIG. 1 is a flowchart of a “Chemistry LAB-IP”, “Rapid Data Awareness (RDA) module, and “Lab-Toaster Data Capture Process” module of an exemplary embodiment of the BioTech Data Portal (BTDS) system;

FIG. 2 is flowchart of a “Biology” module inclusive of a “Fluid Assay Builder (FAB)” module and a “Assay Data Entry Process” module of an exemplary embodiment of the BioTech Data Portal (BTDS) system;

FIG. 3 is flowchart of an “Inventory & Supply Management” module inclusive of an “User Interaction with Inventory Objects” module of an exemplary embodiment of the BioTech Data Portal (BTDS) system; and

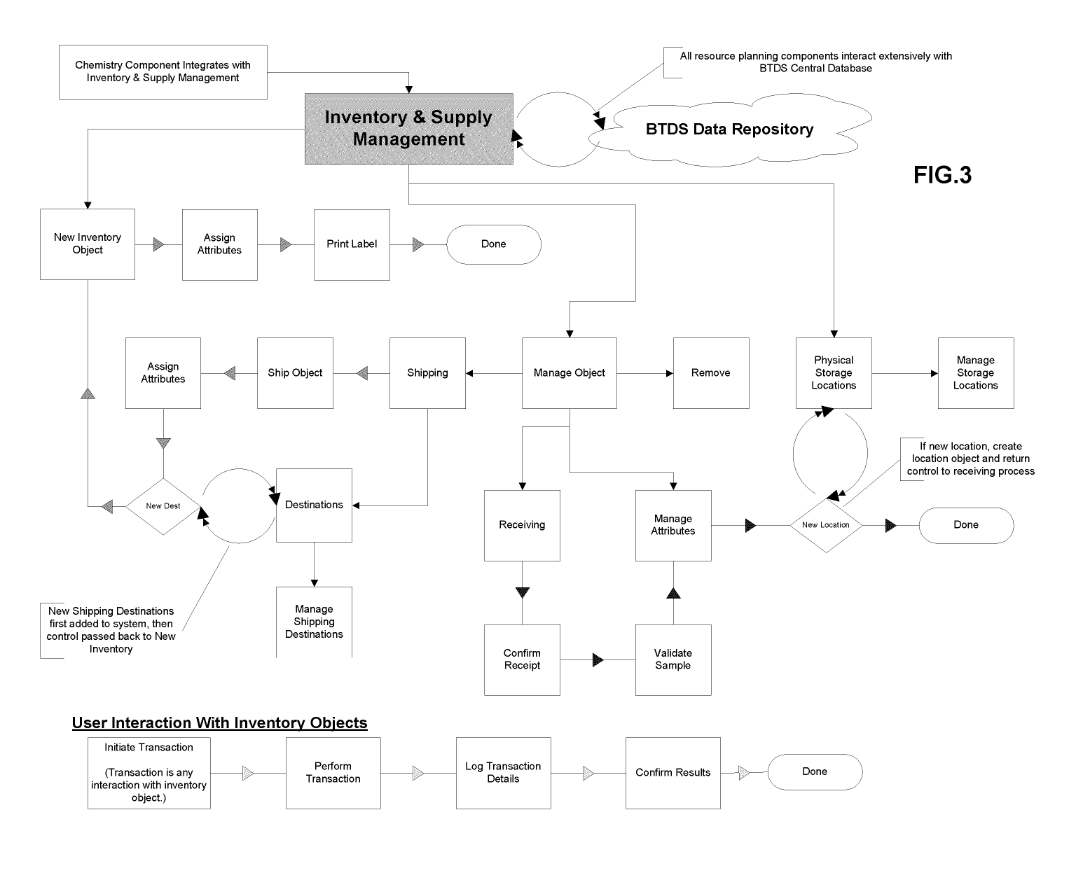

FIG. 4 is flowchart of a “Regulatory Document Management” module of an exemplary embodiment of the BioTech Data Portal (BTDS) system.

### DETAILED DESCRIPTION OF THE PREFERRED EMBODIMENT

The BioTech Data Portal (BTDP) system combines a wide array of research and development, regulatory, and business process data into a single repository, accessible through a comprehensive Web-based user interface in a controlled environment. The following describes an exemplary application of the BTDP in an emerging pharmaceutical research and development organization. It is to be understood that the modules are integrated and interactive between the different components and therefore the steps in the exemplary embodiment described here can be applied in a logical and fluid order, although not necessarily in the order described in the exemplary embodiment described herein.

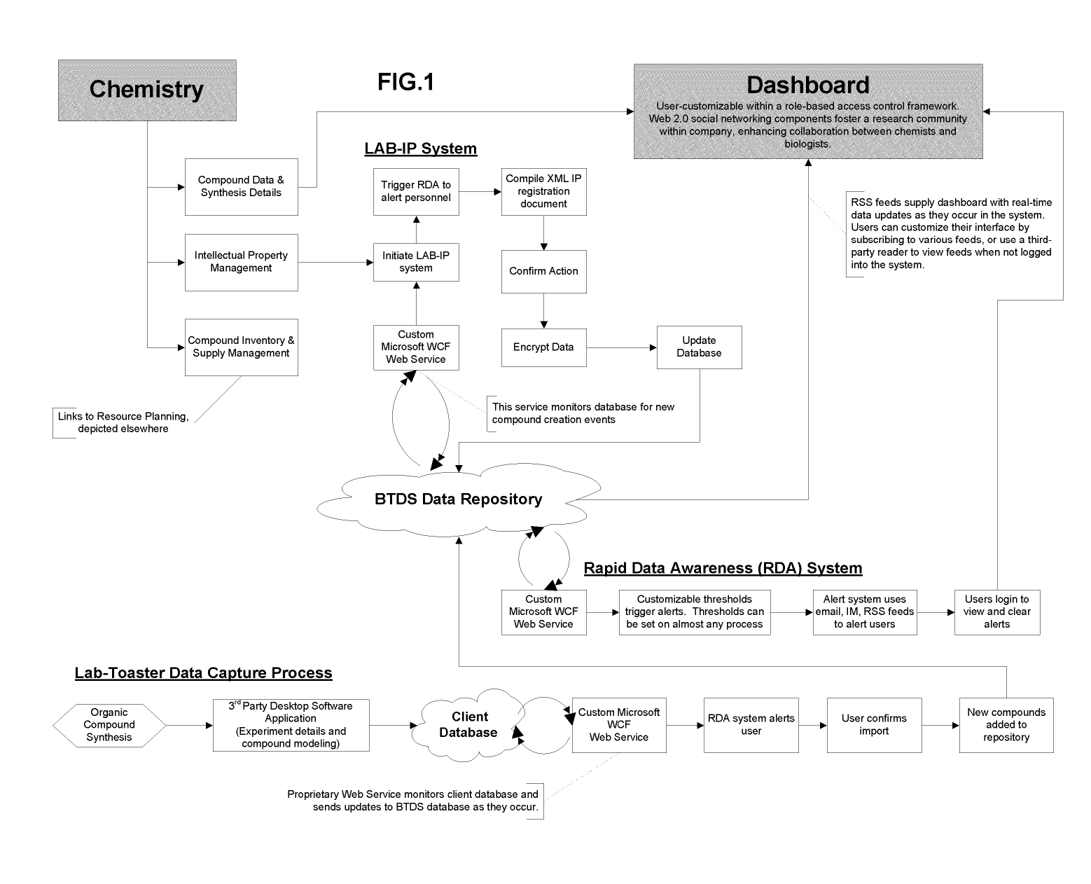

In an exemplary embodiment as is shown in FIG. 1 a LAB-IP System for the chemistry research and discovery workflow module, is described, inclusive of the preliminary steps of compound synthesis and formulation, through validation.

In an exemplary embodiment, as is shown in “Lab-Toaster Data Capture Process” compound synthesis can be contracted to a 3rd party vendor. Following compound creation, the chemists can log the compound structure, composition, and production notes into a legacy desktop-based application. This application provides compound modeling functionality, and serves as a replacement for paper-based data storage.

As described and in this exemplary embodiment, a legacy application can be deployed on a server, located, for example, in the laboratory where the work is performed, creating a data silo, which in an example can be inaccessible to anyone outside the laboratory working group. Report generation in the BTDS system can decrease the amount of time from the formulation steps to the analysis by downstream researchers and/or users of the system by eliminating the manual assembly and delivery of reports to the appropriate personnel.

Referring again to the LAB-IP module, entering and/or storing the data from compound synthesis into the BTDS system can trigger an automated data import and alerting process in the Rapid Data Awareness (RDA) subsystem. For example, the data import process can be initiated by the RDA alert system which can monitor the legacy database for creation and update events. When an update or creation event is triggered the agent monitoring the chemistry software sends a data package containing the updates to the BTDS central data repository. Such changes in the BTDS can for example, be automatically accepted into the BTDS system, and/or reviewed and accepted on a case by case basis. A user who is responsible for managing the compounds can be notified on an interval basis on the number of changes that have occurred in the system since their last login. This approval and import system can also have an audit trail for each transaction approved into the system.

In an exemplary embodiment the BTDS system can implement a Web Service, built on Microsoft Windows Communication Foundation (WCF), to handle importing compound data into the central data repository. Data sent from the agent to the central service is encrypted using a PKI (Public Key Infrastructure) encryption scheme and transmitted using a 128-bit SSL (Secure Socket Layer).

In another embodiment, the BTDS Lab-Toaster subsystem interfaces with an array of laboratory appliances that, for example, are utilized during compound genesis in accordance with, for example the RS-232 protocol connecting data terminal equipment and exemplary data circuit-terminating equipment. A custom XML schema (conforming to the eCTD standard) can provide a method for transforming instrument-specific output to a common format which complies with regulatory requirements and is able to exist as relational data in the central database. The instrument output data can be added to the local server and included in updates to the central repository, as indicated above, including encryption and secure transmission.

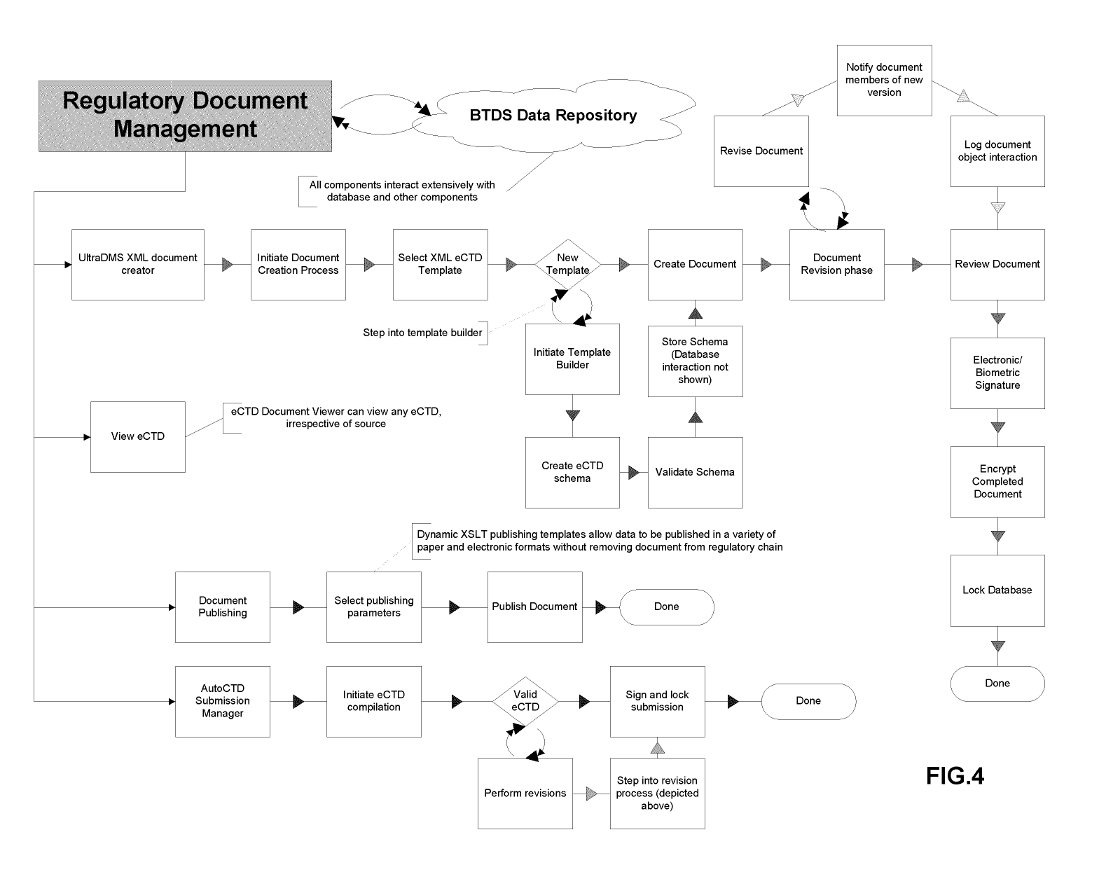

Referring now to FIG. 4 when a compound creation event is detected in the central BTDS data repository, an electronic Common Technical Document (eCTD) object can be created in a Regulatory Document Management module, wherein the document created can be specific to the individual compound. The BTDS AutoCTD function can selects the correct XML schema based on compound parameters and create an XML document by applying schema to newly imported compound data (eCTD XML Schemas and DTDs are managed in the AutoCTD Manager). The created eCTD becomes the framework on which future data relating to this compound is structured, and also can establish a data chain for the compound at a designated and defined time point in the research and development cycle.

In another embodiment, the BTDS LAB-IP module can also be structured on the eCTD model as described above. For example, when a new compound is detected in the central data repository, the LAB-IP module can initiate the creation of an XML-based intellectual property registration document. A data record pertaining to compound synthesis can be generated, compiling data into a template-based form, ready for use in the IP protection process. In another embodiment of the invention, upon completion of the IP registration process, the BTDS LAB-IP system can trigger the BTDS RDA (Rapid Data Awareness) module to commence notification procedures. In this exemplary embodiment the RDA module can use a combination of alerting mechanisms, for example, email, text/instant messaging, and RSS feeds, to alert company personnel to events as they occur in the central data repository. RDA services can be based on the Web 2.0 model, for example such services can be offered on a subscription basis, allowing approved personnel to subscribe to various events which pertain to the user's role in the organization. In one exemplary embodiment, the RDA module can alert appropriate personnel to facts, such as a new compound registration, thereby enabling the IP protection process to be initiated. In an alternative embodiment the RDA can be triggered, for example, by user-customizable thresholds set on research and business process data, enabling a user selected system event to trigger the RDA module.

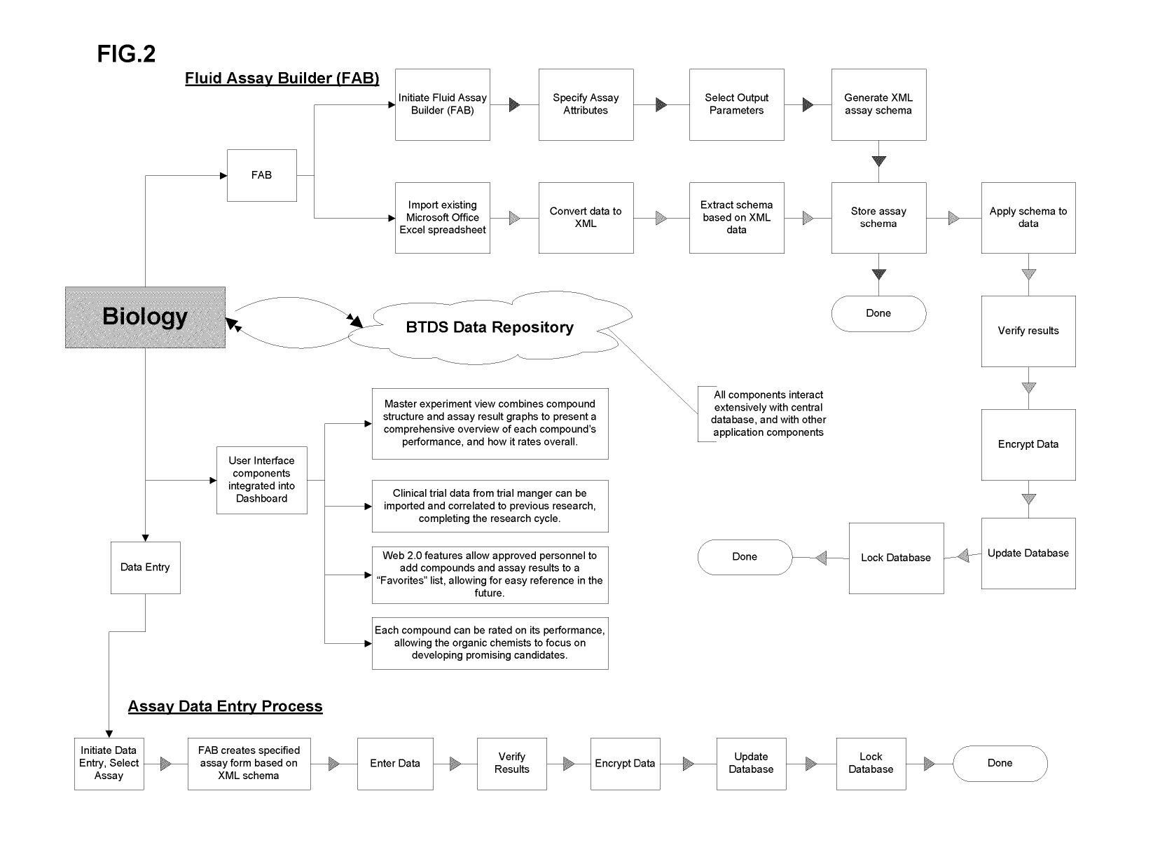

Turning now to FIG. 2, in an exemplary embodiment a biological and/or medical research and discovery workflow module is described, from the preliminary steps of pre-clinical experiments to clinical trials, and FDA regulatory approval.

In an exemplary embodiment, a biological research component consists of a BTDS FAB (Fluid Assay Builder) tool and Assay Data Entry Process module. In this example, the BTDS FAB, is a XML-based component allowing researchers to create custom templates using a drag- and drop interface to assemble experiment criteria, data points, and output parameters into an XML schema in compliance with the eCTD specification. Once defined the assay schema joins the schema library, where it is available for use during the data import process. As experiments are performed, data can be correlated to the appropriate subject compound by using the compound's unique identifier.

In another embodiment, a data entry process is initiated, wherein, and as one step, an assay schema can be selected. Next, the FAB can examine the schema to determine the structure that the data entry form should take. XML metadata in the schema informs the FAB which user controls are required in the form, and the form can be built dynamically on the Web server and made available for data entry.

In another embodiment, and in addition to creating custom assay result sets manually, the FAB can be used to generate XML assay schemas based on legacy documents, such as, but not limited to, Microsoft® Office Excel documents. For example, when an Excel file is dropped into the FAB interface the document can be converted to an XML file. A schema can be generated from XML file from containing the data, and validated against the eCTD specification. Upon approval of a user the schema can be added to the library and data import can be performed.

In another embodiment, subsequent data importation of similar documents, such as Excel spreadsheets, can be achieved by selecting an assay schema and dropping the file into the FAB interface. The XML transformation process occurs and the data can be aggregated using the selected schema for validation.

In another exemplary embodiment and using a dynamic form building functionality of the FAB, researchers can generate data entry forms based on schemas extracted from legacy documents, such as, but not limited to, Excel files. The dynamic form building functionality allows the researcher to create an assay schema from the selected file, enter the legacy data by dragging and dropping the spreadsheet files into the interface, and perform future data entry tasks in the BTDS FAB interface.

In another embodiment of the invention, FAB functionality can include the ability to specify that custom data transformations to be applied to research data. For example, researchers can manipulate and analyze data sets, entering data points into equations, and specifying a variety of charting and graphing options to analyze the data as manipulated. Data transformations can be applied individually to specific datasets, or across the entire data repository, to all data that matches the corresponding schema. This can allow users to analyze data sets repeatedly with different criteria, without having to alter embedded formulas and regardless of the date of the original experiment.

In another embodiment of the invention, transformed data can be assembled into an XML document conforming to the XML file. The eCTD specification document can be made available to authorized personnel comprising, for example, the organization's research community.

In another embodiment of the invention a dataset document can become the seed for a community forum thread, exposing the document for discussion in the BioTech Data Portal forums. In this example, a document can be signed and locked, and a discussion thread can be added to the prospect compound's eCTD for inclusion in regulatory submission applications.

In another embodiment, users can navigate through research documents and can vote on, for example, the viability of each candidate compound based on analysis of the data. An exemplary embodiment of the system can implement a polling protocol to establish community consensus regarding the path future research should follow, for example utilizing the Web 2.0 technique.

Another embodiment of the invention can utilize a forum-based research discussion and polling process, wherein the social networking functionality of link-sharing can be leveraged to allow researchers to share data that they regard as interesting and/or worthy of future investigation and/or development.

In another embodiment, the BTDP provides a means by which researchers can participate in a live chat room, and share ideas in real-time. When the chat session concludes, the host can be able to designate that the transcript from the session be added to the eCTD for the subject compound. In an exemplary embodiment, the record can be transformed to an XML document conforming to the appropriate eCTD schema.

In another embodiment of the invention, researchers are able to bookmark interesting and/or relevant data, and post these bookmarked results to the rest of a community and/or working group through a comprehensive role-based user profile framework.

In an exemplary embodiment of the invention the functionalities described above and others can collectively harness Web 2.0 methodologies to produce a dynamic research community while maintaining a strict audit trail and the data integrity required by regulatory agencies. As mentioned above, research data, forum discussions, chat room manuscripts, and other electronic data and communications can be XML-based and in compliance with the eCTD schema and DTD parameters.

In an another embodiment of the invention, metadata included with data containing documents identify the prospect/candidate compound, and allows a rich taxonomy to be applied to the data. The BTDS AutoCTD system can compile XML-based documents from a plurality of data sources containing a variety of data types in the repository, including, for example, non-XML based relational data from legacy applications. AutoCTD can use taxonomy keywords to correlate relevant data per the user's requirements and assemble XML-based documents that can conform to, for example, the document-level schema and the overall eCTD specifications.

Turning now to FIG. 4, in another embodiment of the invention, data-containing documents can be created by a plurality of individuals throughout, for example a company and/or a working group on a variety of word-processing platforms. A BTDS document management system (Ultra-DMS) can provide a semantic framework in which these data-containing documents may be aggregated, classified, and/or utilized during, for example, the entire chemical compound life-cycle—and in particular in compliance with regulatory requirements.

In another embodiment of the invention, a document import process can be initiated by the user when a document is dropped into the Ultra-DMS interface. The user can be prompted to set values for a variety of document variables, at which time the Ultra-DMS can encapsulate the document in an XML wrapper. A plurality of document variables, for example, and including access and chain of custody record variable, can be stored as metadata within the XML wrapper. In this manner a historical record of the document can be become an integral component of the document itself.

The Ultra-DMS interface can also allow the importation into the BTDP system of reporting documents, such as Clinical Study Reports (CSR). An array of data-conversion functionalities can provide a means to make proprietary Study Report formats available to the BTDP system as relational data, which can then be manipulated and processed by the user upon command. Within its XML wrapper, the CSR can be accessible to the BTDS AutoCTD system for easy inclusion in the regulatory submission framework.

In an exemplary embodiment of the invention, taxonomy is applied to documents in the BTDP repository in multiple ways. For example, a rigid system-controlled vocabulary can be associated with each document schema, and referenced when manipulating data on a system wide level, such as when preparing reports or compiling the eCTD. In another example, documents derived from research data, forums, and the like, can be associated with a specific taxonomy assigned by the system. System-level taxonomy phrases can be stored as metadata in the document's XML wrapper.

In another embodiment, free-taxonomy can provide the users with the flexibility to create their own vocabularies and assign taxonomy phrases to their research, forum discussions, chat sessions, and the like and/or in a manner that makes most sense to each individual user. These taxonomies are associated with the user's profile, and provide a method for researchers to make sense of even enormous amounts of data that they navigate on a daily basis.

Document revision can be handled in a controlled fashion. In one embodiment, users can check a document out of the BTDS repository, wherein the system determines when and if and only a user can access a document at a time, thereby limiting access. The document can then be checked back into the system before other users are allowed access to the revised document. Each revision can be logged separately, establishing a complete record of changes made by users during the history of the document. In this example, and because of a restricted check-out/check-in policy, changes to the document can be tracked, for example, when the changes were made, what changes were made, and by whom the changes were made.

When document collaboration is concluded the contents can be verified for accuracy, preferably by an author or a manager of the content. Once verification occurs, the document can be signed, for example, electronically by either entering a secret PIN number and/or by using a biometric device such as a thumbprint scanner. Signed documents can be automatically locked in the BTDS database so that other revisions are disallowed without a signor's approval.

In another embodiment, data-containing documents can be published in a variety of formats to suit international publishing standards as required in a global marketplace. For example, the AutoCTD system can compile an XML document using a pre-defined XSLT template that conforms to local publishing parameters. Once compiled, the document can be sent to a printer, and/or converted to the Adobe PDF format for electronic distribution.

As described in FIG. 4, a central feature of the BTDS Regulatory Document Management system is the BTDS AutoCTD. This system uses the eCTD schema and DTD required by regulatory agencies for electronic submission of applications. The AutoCTD system can examine metadata associated with data objects to determine which data to include in the eCTD submission. When a user initiates eCTD compilation, AutoCTD can compile non-XML based data into XML documents, using the document-level schemas associated with the data. Once data relating to the subject compound has been aggregated into XML-based documents, the system can insert those documents into the eCTD, using the eCTD specification to determine the correct correlation of data. AutoCTD can deliver a complete record of compound creation, pre-clinical research, and clinical trial data in the required eCTD format, in a nimble and convenient way while also ensuring that only the most current versions of documents and data are used in the submission. Once the eCTD has been compiled, AutoCTD can perform an automated validation routine against the applicable regulatory agency's schema and DTD to ensure a seamless submission process.

After the eCTD has been compiled and validated, a built-in eCTD viewer provides an intuitive user interface for browsing the complete eCTD. This exemplary interface can provide an overall view of the document structure providing the means by which a user can find and examine sections of the document. The Web-based interface and role-based user access controls allow the completed document to be accessible to outside reviewers such as regulators, investors, and outside research partners.

In another embodiment of the invention, a barcode-based inventory control process is initiated when new compounds are detected in the system. New compounds can be assigned unique inventory IDs, and these IDs can be utilized by all processes throughout the research, development, and commercialization lifecycle to correlate data to the corresponding compound. The inventory IDs also serve to establish parent-child relationships between the compounds in the system, so that a clear and concise record of compound genesis is available to the user, IP protection, and regulatory components of the system.

Upon completion of compound synthesis and corresponding documentation procedures, the user is able to interact with the newly created inventory object using the interface. Here, the user can perform a variety of tasks, such as print barcode labels and ship or receive compounds.

When a compound is selected for shipping, the inventory management system can generate a child inventory object with attributes such as mass, destination, and the like. This object can be further divided for shipping if required, each division generating yet another child object and establishing the relationship hierarchy. User interactions with inventory objects, such as shipping, receiving, and use events, can, in an exemplary embodiment, require a digital signature, to be logged and audited. The record of this chain of control can be made available to the AutoCTD for inclusion in the regulatory submission process.

In another embodiment of the invention, the BTDS system can also include functionality that allows researchers to track the physical location of biological, chemical, and/or other research samples within the laboratory environment, including visualizations that assist in locating samples within vast storage matrices.

During the research process, compound usage can be tracked and counted against the master sample store. User-customizable thresholds can be set on compound quantities trigger the BTDS RDA system to alert the appropriate personnel as levels near depletion. This functionality can function to maintain a steady supply of subject compound samples to the research partner laboratories, thus eliminating delays in the research and development cycle which can be both costly and time consuming.

In another embodiment of the invention, the BTDP system can combine all of the systems functionality described above into a simple and user-friendly Web-based interface/portal. This exemplary interface can make use of technologies such as, but not limited, to Microsoft® ASP.Net, AJAX, JSON, and Microsoft® SilverLight™ to provide a rich, seamless user experience. In an exemplary embodiment upon verification of login credentials, the user can be directed to their home page. This page can be a user-customizable dashboard, incorporating process oversight, reporting, site navigation, system RSS feeds and alerts, and social networking (e.g., chat, forum) and community feedback (e.g., polling) functionalities. From this dashboard, the user can all access BTDS components such as the FAB (Fluid Assay Builder), AutoCTD, and their customizable RDA (Rapid Data Awareness) settings and alert logs. In addition to the functionality provided by a full version of the BTDP system web-based interface, a streamlined, compact edition can be available to mobile device users, delivering crucial data to highly mobile personnel. For example, and when combined with the BTDS RDA system, the mobile interface can provide real-time data awareness across all levels of the company or organization.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for managing research data, the method comprising:
receiving user input, the user input further comprising user information transactions and research data sets;
storing the user information transactions and the research data sets;
managing the user information transactions and the research data sets;
tracking entry of the user input;
alerting designated personnel in real-time of the entry of the user input; and
controlling information transactions between users and the user input.

2. A system for research data management comprising:
a computer network;
a plurality of computers for user input;
a central server connecting said plurality of computers;
an input module at the plurality of computers for receiving user input, said user input comprising user information transactions and research data sets;
a repository module in the central server for managing the user information transactions and the research data sets;
a real-time automated alerting module in the central server for tracking when the user input is communicated to the system and communicating the user input to designated personnel;
a transaction management module in the central server which controls information transactions between users and the repository module.

3. A computer implemented interactive research management system comprising:
hub computer processing means for providing a research database with a plurality of datasets and for updating the database in response to at least one data input event;
base station processing means including:
means for generating a real-time alert for an individual user based on the at least one data input event;
means for correlating the at least one data input event and updating relevant data to the research database;
means for evaluating and analyzing the at least one data input event based on at least one existing data set;
means for generating and storing at least one research report based on the at least one data input event and the at least one existing data set;
means for customizing a user interface to the research database; and
remote access means for accessing the base station processing means transmitting the data input event and reviewing the at least one data input event, existing data set and research report.
